(19) United States
(12) Patent Application Publication
(10) Pub. No.: US 2013/0287675 A1
(43) Pub. Date: Oct. 31, 2013

(54) Removal of Bromine From Gaseous Hydrogen Bromide

(71) Applicants: William B. Harrod, Minden, LA (US); John M. Harden, Magnolia, AR (US); Gary L. Sharp, Magnolia, AR (US); Robert E. Williams, Magnolia, AR (US)

(72) Inventors: William B. Harrod, Minden, LA (US); John M. Harden, Magnolia, AR (US); Gary L. Sharp, Magnolia, AR (US); Robert E. Williams, Magnolia, AR (US)

(73) Assignee: Albemarle Corporation, Baton Rouge, LA (US)

(21) Appl. No.: 13/997,964

(22) PCT Filed: Dec. 28, 2011
(86) PCT No.: PCT/US11/67529

§ 371 Date: Jun. 25, 2013

Related U.S. Application Data
(60) Provisional application No. 61/428,100, filed on Dec. 29, 2010.

(51) Int. Cl. C01B 7/09

(52) U.S. Cl. CPC C01B 7/093
USPC 423/488

(57) ABSTRACT

A new, highly selective way of removing bromine contamination from a gaseous stream comprised of hydrogen bromide and bromine is described. Such process technology involves non-catalyzed free radical (benzylic) bromination of an alkylene-bridged aromatic hydrocarbon and/or certain alkyl-substituted aromatic hydrocarbons and recovering the purified gaseous HBr. Because of the high selectivity of the bromination on the aliphatic bridges or side-chains, virtually no ring bromination occurs, and this enables recovery of the bromine values in the form of HBr. Thus preferably, the bromine is recovered as HBr from the scrubbing liquid by subjecting the scrubbing liquid to thermal or catalytic dehyrobromination. In plant operations, the gaseous HBr purified in the process can then be introduced into a compressor to produce either liquid or gaseous HBr for storage under pressure. Alternatively, the purified gaseous HBr can be fed directly into one or more reactions in which HBr is used as a reactant.

### TECHNICAL FIELD

This invention relates to new ways of purifying vapor phase mixtures of gaseous hydrogen bromide contaminated with gaseous bromine.

### BACKGROUND

Processes for producing brominated flame retardants typically yield a co-product mixture of hydrogen bromide (HBr) which is contaminated with bromine. It is useful to remove this bromine for purposes of both protecting equipment against corrosion and for synthetic uses of this HBr. The most efficient HBr purification currently uses Lewis acid catalyzed electrophilic aromatic substitution to partially ring brominate activated aromatics such as diphenyl oxide or 1,2-diphenylethane. Alternatively, older technology has been tested wherein bromine is adsorbed on carbon and reduced with hydrogen at 400-600° C. to form HBr. Each of these purification procedures possesses shortcomings due to inherent safety issues and unattractive economics in large scale operations, respectively. Additionally, the Lewis acid catalyzed electrophilic aromatic substitution purification process has a severe drawback in that the bromine cannot be economically recovered from the scrubbing liquid which means that the scrubbed bromine is lost and has to be disposed of. It would be highly advantageous if a way could be found of purifying such HBr efficiently, safely, and economically in large scale operations.

### BRIEF NON-LIMITING SUMMARY OF THE INVENTION

In accordance with this invention, there is provided new process technology for selectively removing bromine from vapor phase mixtures of gaseous hydrogen bromide (HBr) and gaseous bromine (Br₂). Such process technology involves free radical (benzylic) liquid phase bromination of (1) one or more alkylene-bridged aromatic hydrocarbons, (2) one or more aryl-substituted linear alkanes having in the range of 2 to about 6 aryl groups per molecule, (3) one or more primary or secondary alkyl-substituted aromatic hydrocarbons in which the alkyl substituents each contain in the range of 2 to 6 carbon atoms, or (4) a mixture comprised of any two or all three of (1), (2), (3) and recovering the purified gaseous HBr. In plant operations, gaseous HBr purified in the process can then be introduced into a compressor to produce either liquid or gaseous HBr for storage under pressure. Alternatively, the purified gaseous HBr can be fed directly into one or more reactions in which HBr is used as a reactant. Additionally, this new process technology makes possible the recovery of the scrubbed bromine in the form of HBr, thus putting to effective use the bromine that has been selectively removed from the initial vapor phase mixture of HBr and Br₂

In conducting the process technology of this invention it is preferred to utilize as the medium in which the free radical liquid phase bromination occurs, a liquid medium containing (1) one or more alkylene-bridged aromatic hydrocarbons and/or (2) one or more aryl-substituted linear alkanes and/or (3) one or more primary or secondary alkyl-substituted aromatic hydrocarbons, all of which are referred to above. While one or more hydrocarbons of (3) are effective in removing the bromine contamination, the alkylene-bridged aromatic hydrocarbons of (1) and the aryl-substituted linear alkanes of (2) are even more effective by virtue of the fact that the saturated hydrocarbon bridge of these compounds is disposed between two aromatic moieties which activate the benzylic portion of the saturated hydrocarbon bridge. This in turn results in reaction conditions favoring free radical bromination with the potential for recovery of the bromide in a useful form, i.e., as anhydrous HBr.

From the standpoints of overall efficiency, lowest cost, and simplicity of operation, the medium containing a liquid phase in which the benzylic bromination takes place should be completely composed of one, or more than one, hydrocarbon which is or includes (1), (2), (3), or (4) above except for brominated species formed therein by the bromination that takes place in the medium. However, other solvents which do not interfere with free radical liquid phase benzylic bromination or otherwise consume bromine under conditions of free radical liquid phase benzylic bromination, can be used.

Preferred alkylene-bridged aromatic hydrocarbons of (1) above comprise those in which the alkylene groups are, independently, linear alkylene groups containing in the range of 2 to 10 carbon atoms, and more desirably 2 to 6 carbon atoms, and wherein each such carbon atom is substituted by 2 hydrogen atoms.

Preferred aryl-substituted linear alkanes of (2) above comprise one or a mixture of two or more of those in which the alkane group is a linear alkane group containing, independently, 3, 5, 7, 9, or 11 carbon atoms, and in which each of the two terminal carbon atoms is substituted with an aryl hydrocarbon group and (i) when the linear alkane group has 5 carbon atoms, the carbon atom in the 2-position is also substituted with an aryl hydrocarbon group, (ii) when the linear alkane group has 7 carbon atoms, the carbon atoms in the 2- and 4-positions are each substituted with an aryl hydrocarbon group, (iii) when the linear alkane group has 9 carbon atoms, the carbon atoms in the 2-, 4-, and 6-positions are each substituted with an aryl hydrocarbon group, and (iv) when the linear alkane group has 11 carbon atoms, the carbon atoms in the 2-, 4-, 6-, and 8-positions are each substituted with an aryl hydrocarbon group. Especially preferred are highly aromatic hydrocarbon mixtures comprised of aryl-substituted linear alkanes of type (2) in combination with an amount of toluene of up to but not more than about 15 wt %, preferably up to, but not more than about 10 wt %, and more preferably up to but not more than about 5 wt % of the total weight of the overall mixture. The aryl groups can be unsubstituted or they can be substituted by straight chain (i.e., linear) alkyl groups each of which contains at least 2, and typically no more than about 4 or 5, carbon atoms. In other words, they should not be methyl-substituted. Preferred aryl hydrocarbon groups are phenyl groups and thus aryl-substituted linear alkanes in which all of the aryl groups are unsubstituted phenyl groups are most preferred.

Preferred alkyl-substituted aromatic hydrocarbons of (3) above are those in which the alkyl substituents are, independently, primary straight chain alkyl groups, i.e., one or more straight chain alkyl groups of the formula CₙH₂ₙ₊₁ in which n is a whole number in the range of 2 to about 6 carbon atoms. Highly aromatic hydrocarbon mixtures comprised of alkyl-substituted aromatic hydrocarbons of type (3) in combination with toluene in an amount of up to but not more than about 15 wt %, preferably up to but not more than about 10 wt %, and more preferably up to but not more than about 5 wt % of the total weight of the overall mixture can be used, although toluene-free mixtures of (3) are especially preferred.

Except for amounts equivalent to or amounts that are slightly more than equivalent to the small amounts of toluene and trace amounts of methyl-substituted aliphatic components having at least two aromatic groups per molecule which may be present in aromatic hydrocarbon mixtures of (2) above because of the processing involved in their preparation and recovery of such mixtures, the scrubbing liquids of this invention are devoid of components having any methyl substitution on an aromatic ring. Methyl ring-substitution on aromatic hydrocarbons in the scrubbing liquid can result in formation of excessive bromomethyl-substitution during use as a scrubber thereby preventing recovery of the scrubbed bromine values by catalytic or thermal dehydrobromination. Trace amounts of such methyl substitution are permissible in the scrubbing liquids used in the practice of this invention as long as at least 90 wt % or more, preferably 95 wt % or more, and more preferably 98 wt % or more of the bromine is recoverable by catalytic or thermal dehydrobromination. In short the higher the amount of bromine that can be recovered from the used scrubbing liquid, the better.

Other features and embodiments of this invention will become still further apparent from the ensuing description and the appended claims.

### BRIEF DESCRIPTION OF THE DRAWING

FIG. 1 is a plot of TGA data from Example 7 showing the release of HBr as a function of temperature for a sample of heavies obtained in the bromination of 1,2-diphenylethane to produce alkylene chain brominated 1,2-diphenylethane.

### FURTHER DETAILED DESCRIPTION OF THE INVENTION

In preferred embodiments this invention provides, among other things, a process for purifying an anhydrous vapor phase mixture comprised of gaseous hydrogen bromide contaminated with gaseous bromine, which process comprises:

A) feeding said vapor phase mixture into a liquid medium that is devoid of any added bromination catalyst, and wherein the medium contains:
(1) one or more alkylene-bridged aromatic hydrocarbon compounds of either or both of formulas (I) and (II):

Ar-alkylene-AE-alkylene-Ar (I)

Ar-alkylene-AE-alkylene-AE-alkylene-Ar (II)
wherein the Ar groups can be the same or different and each Ar is, independently, a C₆₋₁₆ unsubstituted or alkyl-substituted aryl group; wherein the AE groups can be the same or different and each AE is, independently, a C₆₋₁₆ unsubstituted or alkyl-substituted arylene group; and wherein the alkylene groups can be the same or different and each alkylene group is a C₂₋₁₀ alkylene group, and more desirably a C₂₋₆ alkylene group, and wherein all of the alkylene groups are, independently, linear alkylene groups, (—CH₂—)ₘ wherein m is 2-10, and more desirably 2-6, and/or
(2) one or more aryl-substituted linear alkanes of either or both of formulas (III) and (IV):

Ar—CH₂CH₂CH₂—Ar (III)

Ar—CH₂[—CH₂CH(Ar)]ₙ—CH₂CH₂—Ar (IV)
wherein each Ar is the same or different and is an aryl hydrocarbon group which can be unsubstituted or substituted by a straight chain alkyl group, each of which contains at least 2, and typically no more than about 4 or 5, carbon atoms, (and preferably each aryl group is an unsubstituted aryl hydrocarbon group such as phenyl, 1-naphthyl, 2-naphthyl, biphenylyl, or anthryl, and more preferably is a phenyl group), and n is a whole number in the range of 1 to about 4; and/or
(3) one or more alkyl-substituted aromatic hydrocarbons of formula (V):

Rₚ—Ar (V)
wherein each R is a straight chain alkyl group, and wherein the alkyl groups independently contain in the range of 2 to 6 carbon atoms, Ar is a phenyl group, a naphthyl group, a biphenylyl group, or an anthryl group, and p is a whole number from 1 to 3; and/or
   (4) a mixture of any two or all three of (1), (2), (3);
   said medium being maintained at about 45° C. to about 110° C. and preferably at about 60° C. to about 110° C. so that free radical benzylic bromination occurs in said medium; and
   B) recovering purified gaseous hydrogen bromide from said medium, and
   C) optionally, but preferably, subjecting residual medium from B) to thermal or catalytic dehydrobromination, thereby producing recoverable or directly useable additional hydrogen bromide.

Desirably, the medium used in the above process contains at least 50 area % and more desirably at least 70 area % (as determined by GC-MS) of above components (1), (2), (3), or (4), the balance, if any, being hydrocarbons that do not interfere with free radical liquid phase benzylic bromination or otherwise consume bromine under conditions of free radical liquid phase benzylic bromination.

In particularly preferred embodiments of this invention the medium of the above process (I) is composed completely of hydrocarbon(s) of (1), (2), (3), or (4), or (II) is composed of a minimum of at least 85 wt %, desirably at least 90 wt %, and more desirably at least 95 wt % of hydrocarbon(s) of (1), (2), (3), or (4). The medium of (I) is particularly preferred because not only is there essentially no undesired aromatic bromination, but additionally because the medium of (I) is devoid of methyl substituents on aromatic rings virtually all of the aliphatically-substituted bromine formed during the reaction can be recovered by subjecting the medium after use in the benzylic bromination to thermal or catalytic dehydrobromination. The medium of (II) is particularly preferred because not only is there essentially no undesired aromatic bromination, but additionally because media of (II) are readily available at low cost and in some cases are waste products of other chemical processes normally requiring suitable methods of waste disposal.

It can be seen from the above that the process not only purifies an anhydrous vapor phase mixture comprised of gaseous hydrogen bromide contaminated with gaseous bromine, but additionally in almost all cases is capable of producing a greater amount of hydrogen bromide than the amount of hydrogen bromide contained in the quantity of contaminated HBr fed into the medium. Also, it will be appreciated that during the process, portions of the hydrocarbon components of formulas (I) to (V) of the scrubbing media, used in the practice of this invention, become selectively brominated exclusively or almost exclusively on the aliphatic portions of such components. In other words, little if any aromatic bromination occurs. Thus, as the feed continues, the medium becomes progressively enriched in aliphatically brominated species. Therefore, the total quantity of the medium comprised of one or more of components of formulas (I) to (V) should be substantially in excess of the amount thereof that will become brominated during the operation. This can be effected by employing a large excess of such medium at the outset or by periodically removing a portion of such medium and replenishing it with fresh unbrominated medium. In all cases the medium will contain essentially only hydrocarbons and brominated hydrocarbons formed in removing bromine contamination from the feed. Accordingly, as long as the medium contains a sufficient excess of one or more components selected from formulas (I) to (V) the particular amount of the medium present during the feed will depend primarily upon the size of the operation and facilities being used.

The components of formulas (I) to (V) that are selected for use in the process are all readily susceptible to free radical benzylic bromination in the absence of an added catalyst by virtue of the presence of activated hydrogen atoms possessed by the alkyl or alkylene substituents in the specified molecules of formulas (I) to (V). Moreover, the products of such benzylic bromination are all readily susceptible to thermal or catalytic dehydrobromination. Consequently, not only is the free radical benzylic bromination of the components of formulas (I) to (V) that have been selected for use, but additionally the total yield of hydrogen bromide readily recoverable in the process can be higher than the total amount of hydrogen bromide initially present in the vapor phase mixture fed to the process.

For convenience, the anhydrous vapor phase mixture comprised of gaseous hydrogen bromide contaminated with gaseous bromine is sometimes referred to hereinafter as “contaminated gaseous HBr” Likewise, the medium into which the feed is made is sometimes referred to hereinafter simply as “scrubbing medium”.

In conducting the processes of this invention it is desirable to feed the contaminated gaseous HBr into (and preferably below the surface of) the scrubbing medium. However, it is possible to effect the contact between the contaminated gaseous HBr and the scrubbing medium in other ways. For example a flow of the contaminated gaseous HBr may be contacted with a countercurrent flow of the scrubbing medium.

The processes of this invention can be carried out in a batch or in a continuous mode of operation.

For most efficient operation, the temperature of the liquid hydrocarbon purification medium should be maintained within the above temperature ranges throughout the entire time the contacting or feed of the contaminated gaseous HBr is taking place. However, it is not necessary to maintain these temperatures throughout the entire time if one is willing to accept some less efficient operation for short periods of time.

As seen from the above, the benzylic aromatic reactant(s) in the scrubbing medium are of three principal types:

(X) one or more compounds of either or both of formulas (I) and (II),
(Y) one or more compounds of either or both of formulas (III) and (IV), and
(Z) one or more compounds of formula (V).
Also, as noted above, mixtures of any two or all three of (X), (Y), (Z) can be used.

Additionally, any other type of hydrocarbons can be present as long as the scrubbing medium has a liquid phase. Preferably, however, the other types of hydrocarbons typically present in commercially available liquid aromatic hydrocarbon compositions or as hydrocarbon overheads, cuts or bottoms from chemical plant operations should be substantially inert to bromine and to HBr.

Illustrative non-limiting examples of compounds of formulas (I) and (II) include 1,4-bis(phenethyl)benzene, 1,4-bis(phenylpropyl)benzene, 1-(phenethyl)-4-(m-tolylethyl)benzene, 1,4-bis(o-tolylethyl)benzene, 4,41-bis(phenethyl)bibenzyl, 4,4′-bis(phenylpropyl)bibenzyl, 4-(phenethyl)-4′-(p-tolylethyl)bibenzyl, and analogous compounds. One particularly desirable class of hydrocarbon media containing compounds of formulas (I) and (II) for use in the practice of this invention are distillation bottoms resulting from the production of 1,2-diphenylethane, a well-known raw material for the manufacture of brominated flame retardants. 1,2-Diphenylethane is produced by the Friedel-Crafts reaction of 1,2-dichloroethane and benzene. See in this connection U.S. Pat. Nos. 2,344,188 and 4,929,785. The distillation bottoms or “heavies” from the production process contain substantial amounts of aromatic hydrocarbons, typically 4,4′-dialkylated bibenzyl compounds along with other hydrocarbon components. In many cases such bottoms have boiling ranges from or higher than an initial boiling point of approximately 284° C. at 760 mm Hg (the boiling point of some diphenylethane which may be present in the bottoms) up to boiling points of about 278° C. at 3 mm Hg. (the boiling point reported for typical 4-ring aromatic hydrocarbons having the formula (C₃₀H₃₀). Small amounts (e.g., up to 1 or 2 area % by GC-MS) of even higher boiling components may be present in such bottoms, such as components of empirical formulas C₃₂H₃₂ and C₃₂H₃₄. The empirical formulas of components of a typical sample of bottoms or “heavies” from manufacture of 1,2-diphenylethane as determined by GC-MS are as shown in the Table:

TABLE 1

| Empirical Formula | Area Percent | Empirical Formula | Area Percent |
|---|---|---|---|
| C14H14 | 1.5 | C21H21 | 0.48 |
| C14H18 | 0.16 | C22H18 | 0.96 |
| C15H16 | 2.15 | C22H22* | 36.9 |
| C16H18 | 3.5 | C24H26 | 1.65 |
| C14H12 | 0.41 | C25H29 | 9.7 |
| C17H20 | 0.57 | C30H30** | 35.78 |
| C16H14 | 1.8 | C32H34 | 0.46 |
| C16H16 | 0.14 | C32H34 | 0.28 |
| C18H18 | 0.37 | C32H32 | 0.44 |
| C20H18 | 1.6 | — | — |

*1,4-bis(phenethyl)benzene
**4,4′-bis(phenethyl)bibenzyl

Preferred mixtures of components of formulas (I) and (II), for use in the practice of this invention, are bottoms or “heavies” formed in the production of 1,3-diphenylethane by Friedel-Crafts reaction between 1,2-dichloroethane and benzene. Such bottoms desirably contain at least 50 area %, more desirably at least 60 area %, and still more desirably at least 70 area % of components of Table 1, such area percentages being determined by GC-MS.

Illustrative non-limiting examples of compounds of formulas (III) and (IV) include 1,3-diphenylpropane, 1,3,5-triphenylpentane, 1,3,5,7-tetraphenylheptane, 1,3,5,7,9-pentaphenylnonane, 1-phenyl-3-(o-tolyl)propane, 1-phenyl-3-(2-ethylphenyl)propane, 1-phenyl-3-(o-n-propylphenyl)propane, 1-phenyl-3-(2-n-butylphenyl)propane, 1-(1-naphthyl)-3-phenylpropane, 1,3-bis(biphenylyl)propane, and analogous compounds. Compounds of this type and mixtures thereof may be produced by processing described in detail in U.S. Patent Application Publication No. 2010/0184941 A1, published Jul. 22, 2010. Particularly desirable for use in the practice in this invention are product mixtures comprised of compounds of formulas (III) and (IV) recovered by wiped film evaporation from product formed by anionic chain transfer polymerization of vinyl aromatic compounds, especially styrene, with toluene as a chain transfer agent and using a promoted anionic catalyst system such as butyl lithium or potassium tert-butoxide and N,N,N′,N′-tetramethylethylenediamine. Such processing is described in U.S. 2010/0184941 A1, published Jul. 22, 2010, in WO 2008/154453 A1 published Dec. 18, 2008, and in WO 2009/148464 A1 published Dec. 10, 2009.

Typical GC-MS data (ex solvent) of wiped film evaporation overhead of aromatics from such processing is summarized in Table 2.

TABLE 2

| Empirical Formula | Compound | Area Percent |
|---|---|---|
| C15H16 | 1,3-diphenylpropane | 56.05% |
| C23H24 | 1,3,5-triphenylpentane | 34.25% |
| C31H32 | 1,3,5,7-tetraphenylheptane | 9.70% |

Illustrative non-limiting examples of compounds of formula (V) include ethylbenzene, n-propylbenzene, n-butylbenzene, isobutylbenzene, sec-butylbenzene, n-hexylbenzene, 1-ethylnapthalene, 2-ethylnapthalene, 4,4′-diethylbiphenyl, 4,4′-di-n-propylbiphenyl, 1-ethylanthracene, 2-butylanthracene, and analogous compounds. Mixtures containing suitable amounts of compounds of formula (V) are available in the marketplace and can constitute economical sources of hydrocarbon media for use in the practice of this invention. Wiped film evaporation overheads used in the practice of this invention, desirably contain at least 50 area %, more desirably 70 area %, and still more desirably in the range of 90-100 area % of components of Table 2, such area percentages being determined by GC-MS.

In those cases where the compound or mixture of compounds of formulas (I) to (V) is in the solid state at room temperature, a suitable liquid solvent, especially any liquid non-methylated aromatic hydrocarbon solvent, may be employed to provide a liquid phase reaction mixture into which the feed of bromine-contaminated HBr is fed. Whenever possible it is usually more desirable to simply heat the compound or mixture of compounds of the hydrocarbon medium in the reactor in order to provide a molten product to receive the bromine-contaminated HBr feed. This avoids the need for handling an additional solvent material and enables use of smaller reaction equipment.

In removing gaseous bromine contamination from the contaminated gaseous HBr feeds in the process of this invention, free radical bromination conditions are used. Thus the reaction between the bromine impurity and the content of the selected components (I) to (V) in the scrubbing medium is typically conducted using elevated temperatures (e.g., about 45° C. to about 110° C. and preferably about 60° C. to about 110° C.), optionally with use of light radiation such as from fluorescent light sources. Use of light radiation tends to improve the efficiency of bromine removal from the contaminated gaseous HBr.

After recovering purified gaseous hydrogen bromide from the scrubbing medium, the residual mixture remaining in the reactor can be recycled or reused in ensuing operations to remove gaseous bromine contamination from gaseous HBr. Alternatively, this residual mixture can be subjected to dehydrobromination whereby additional gaseous hydrogen bromide is produced. In such a case essentially all of the initial bromine contaminant of the gaseous HBr is not only removed from the HBr, but is converted into HBr.

The feed rate of the vapor phase mixture into the anhydrous liquid reaction mixture can be varied. Among the factors to be taken into consideration are the scale of operation, the residence or contact time of the feed in the body of the liquid phase reaction mixture, the temperature of operation, the amount of bromine contamination in the feed, and the like.

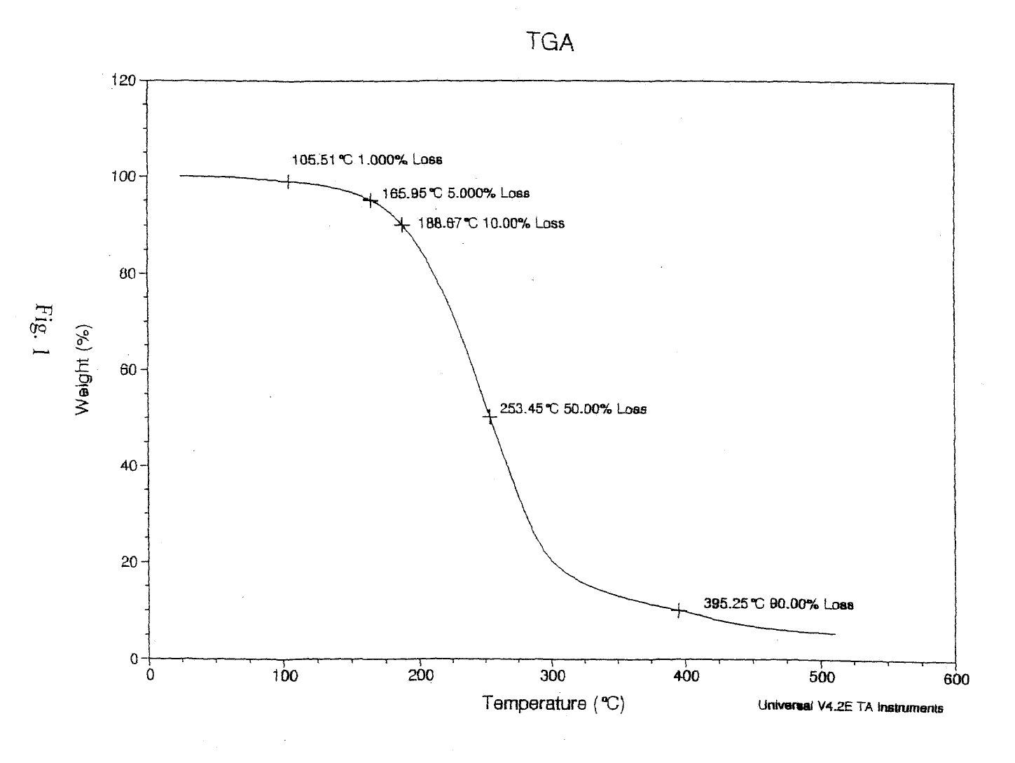

Generally speaking, feed rates can be varied as long as the feed rate is not so slow as to make the process operation uneconomical or so fast as to result in incomplete removal of unduly large amounts of HBr from the feed. Thus, when using heavy hydrocarbon bottoms from 1,2-diphenylethane production, controllable variables are temperature, density and viscosity. For example, in an illustrative limiting case (Example 7 hereinafter) where a sample of bridged brominated oligomers of 1,2-diphenylethane (i.e., bottoms from 1,2-diphenylethane production), produced in the absence of any added catalyst, viscosity data indicated that the optimum flow of temperature for that sample was 105° C. with a viscosity of 17.0 centipoise (cP). The viscosity at 90° C. was 84.5 cP. No significant flow of liquid was detected at 80° C. The density at 90-105° C. was 1.28-1.30 g/mL. At 80° C., it was 1.31 g/mL. TGA and DSC indicated significant dehydrobromination especially over the range of 165-270° C. The 1 wt % loss occurred at 105° C., the 5% wt loss temperature was 166° C. and the 50% wt loss temperature was 253° C. See in this connection FIG. 1.

In operation on a laboratory scale, desirable feed rates will typically be within the range of about 20 mL/minute to about 40 mL/minute per each 250 g of scrubbing medium. More typically, laboratory feed rates will be within the range of about 25 mL/minute to about 35 mL/minute, (e.g., approximately 30 mL/minute), per each 250 g of scrubbing medium present in the scrubbing reaction vessel.

Residence or contact times of the feed within the body of the scrubbing medium are also susceptible to some degree of variation. Typically, the operation will be conducted such that the average time the gaseous feed remains within the body of the scrubbing medium will be in the range of about 20 mL/minute to about 40 mL/minute.

From the foregoing discussion of feed rates, temperature, density, viscosity and residence or contact times, these parameters for any given heavy hydrocarbon medium can be readily determined using a few tests using the above values as guideposts. Scrubbing liquids with relatively low viscosities and densities of the type described herein do not involve these considerations since they are mobile liquids at suitable reaction temperatures and pressures.

As noted above, the liquid phase reaction mixture is maintained at an elevated temperature sufficient to enable free radical bromination to occur between the bromine contaminant and the benzylic aromatic reactant (selected components of (I) to (V)) being employed.

The reactor in which the process of this invention is conducted will typically be at approximately atmospheric pressure. However, if desired, modest superatmospheric pressures (e.g., in the range of about 0 psig to about 5 psig) or modest subatmospheric pressures (e.g., in the range of about 740 mm Hg to about 760 mm Hg) can be employed.

It will be understood that a feature of this invention is that no bromination catalyst is introduced into the liquid phase reaction mixture. Not only is this a cost-saving feature, but additionally, use of a catalyst-free scrubbing medium focuses the bromination reaction onto the activated alkylene bridges or primary or secondary alkyl side chains of the selected components of (I) to (V) being used.

To enable formation of more HBr than that present in the amount of HBr contaminated with bromine (Br₂) processed, the scrubbing medium used in the processing is subjected to thermal or catalytic dehydrobromination. Generally speaking, thermal dehydrobromination is brought about by heating and maintaining the scrubbing medium at elevated temperature(s), typically in the range of about 105-106° C. (the onset temperature of the reaction per DSC data) to about 250° C., for 3 to 12 hours, preferably at temperature(s) in the range of about 175-250° C. for 5 to 8 hours, in which benzylic dehydrobromination proceeds rapidly, and more preferably at temperature(s) in the range of about 225-250° C. for 1.5 to 3 hours to ensure complete thermal dehydrobromination. In the presence of selected Lewis acids including FeBr₃, FeCl₃, and AlCl₃ the time at the temperature range of about 140-225° C. can be decreased such that the dehydrobromination process can be performed in a continuous manner (e.g. in less than 2 hours) using secondary alkyl bromides which as a group are less reactive than primary alkyl bromides.

The following examples are presented for purposes of illustration. They are not intended to impose limitations on the scope of the subject matter in the claims hereof.

Comparative Example A illustrates a simulated scrubber procedure in which known catalytic technology is used to achieve appreciable aromatic ring bromination along with bridge bromination.

### Comparative Example A

A jacketed 500 mL gas absorption bottle was placed between a gas inlet and a water scrubber comprised of a second gas absorption bottle containing water (81.89 g final wt). Both were stirred using a hot plate stirrer and a 1-inch stir bar. Bromine (2.78 g 17 mmols) was conveyed over ca. 1.5 hours into the primary scrubber, which contained 197.160 g of oligomeric diarylethanes (0.583 mol at an avg MW of 338 g/mol) and aluminum chloride catalyst (0.42 g; 1.5 mmol). The primary absorber had an oil jacket which had an average temperature of 65 C. Upon completion of the experiment, it was noted that the water scrubber was entirely colorless, indicating that all bromine had been reacted in the primary absorber and no detectable bromine had carried forward into the water absorber. This was confirmed by the absence of any significant color observed upon addition of an analytical aliquot (ca. 2 g) into a solution of 20 mL of 20% potassium iodide in 100 mL of 6N H₂SO₄. HBr recovered in the water absorber was 71.63% of theory with the balance being solubilized in the organic portion. To determine the amount of recoverable HBr in the organic product, it was analyzed by ¹H-NMR using a Bruker 400 MHz FT-NMR (4 scans, 30° pulse, 90 second delay) and using chloroform-d as solvent. Analysis of the aliphatic portion (δ2.7 ppm-0-5.5 ppm) of the complex mixture showed products of bridge bromination (59.94% wt). Aromatic bromination products comprised 39.74% wt. The bromide from aromatic bromination is unrecoverable as HBr by conventional thermal or catalytic dehydrobromination technology. Analysis of the olefinic region showed that only 0.32% wt of the organics were produced by dehydrobromination in the course of the experiment.

Examples 1-6 below demonstrate the use of this invention in effecting bromine removal from contaminated gaseous HBr without use of an added catalyst. In these Examples a precisely known quantity of bromine feed was used in lieu of a feed of a gaseous HBr stream contaminated with bromine. In this way, not only is the accuracy of the measurements increased but, additionally the test procedure is simplified.

GC-MS data were acquired using a Waters AutoSpec Premiere GC with MassLynx 4.1 software. The GC oven was programmed with an initial temperature of 50° C., held for 1 minute, then increased at 10° C. per minute to 300° C. and held for five minutes at 300° C. The inlet temperature was 280° C. with a split ratio of 100:1. The column was a mid-polarity column (Agilent Technologies, DB-17hs; 30 m×0.25 μm with a 0.25 μm film).

### Example 1

A preheated (80° C.) 250 mL three necked round bottomed flask, equipped with a Friedrichs condenser (25° C.), was loaded with 93.523 g (0.277 mol) of a solution containing 36.9% three ring aromatics (including p-Bis(phenylethyl)benzene), 35.78% four-ring aromatics, including 4,4′-(diphenylethyl)bibenzyl, and the balance being structurally similar aromatic components. The reactor overhead was connected by ¼ inch polytetrafluoroethlyene (PTFE) to 110.94 g of water scrubber solution contained within a 250 mL gas absorption bottle. A secondary scrubber contained 15 mL of CCl₄ to trap any traces of residual bromine Bromine (2.616 g, 0.016 mol) was vaporized and conveyed at 30 mL/min through a ⅛ inch PTFE tubing as a subsurface feed (ca. ½ inch below liquid) into the reaction mass (initially at 105° C.). The evolved gas contained nitrogen, HBr, and was essentially free of bromine. After 1 hour and 12 minutes, the addition step was completed and after a total time of 1 hour and 23 minutes, the reaction mass and scrubber solutions were isolated and analyzed. Bromine removal was evidenced by the colorless appearance of the scrubber and its low bromine content (<28 ppm). The secondary scrubber (CCl₄) was also colorless after the feed and cook steps.

Examples 2 and 3 illustrate processes of this invention in which a mixture of compounds of B) are used in forming an anhydrous liquid phase reaction mixture.

### Example 2

A preheated 250 mL three-necked round bottomed flask, equipped with a Friedrichs condenser (12° C.), was loaded with 42.68 g of a solution comprised of 1,3-diphenylpropane (69.54%), toluene (9.50%) and 20.96% structurally similar aromatic compounds. The reactor overhead was connected by ¼ inch PTFE to an alkaline water scrubber solution (110 mL H₂O, 15 mL 25% NaOH) contained within a 250 mL gas absorption bottle. Bromine was vaporized and conveyed at 30 mL/min through a ⅛ inch PTFE tubing as a subsurface feed (ca. ½ inch) into the reaction mass (46-51° C.). The evolved gas contained nitrogen and HBr which was essentially free of bromine Analysis of the colorless primary scrubber (153.93 g including rinse water) showed 2.79% bromide and, after acidification, addition of 20% KI, and titration with 0.1N Na₂S₂O₃, we noted 76 ppm bromine (0.004 g total or 0.04% of the initial bromine) This indicates removal of 99.96% of the bromine from the eluent gas.

### Example 3

In this operation a wiped film evaporator (WFE) overhead mixture was employed as the anhydrous liquid phase reaction mixture. This WFE overhead was a mixture obtained from a product formed in a manner similar to that described above under the heading “1) Preparation of an Aromatic Polymer” and isolated by use of a WFE in a manner similar to that described above under the heading “2) WFE Recovery of an Overhead Product”. Into a 42.68 g sample of such a wiped film evaporator (WFE) overhead was fed 10.08 g bromine (the limiting reagent such as would be present in a bromine-contaminated HBr stream) over a period of 2.5 hours. The reaction zone was maintained at 49-53° C. and the vent path passed through an overhead Friedrichs condenser (12° C.) and was trapped in a NaOH scrubber. Under these conditions the bromine conversion was 98.04% and only 0.04% of the initial bromine eluted to the vent. The organic reaction mixture was analyzed by NMR spectroscopy. This showed that side chain bromination products were formed. Actual yield of the organic portion was 44.97 g (vs the theoretical amount of 43.45 g). This organic portion included such materials as 1,3-diphenyl-monobromopropane and 1,3,5-triphenyl-monobromopentane. Since toluene was also present in the WFE overhead, benzyl bromide a secondary side reaction from bromination of toluene, was quantified (0.48 wt %).

The much higher efficiency made possible by this invention in effecting bromine removal from gaseous HBr contaminated with free bromine is illustrated by Examples 4 and 5 of this invention as compared to Comparative Example A representing a prior art procedure.

### Example 4

A preheated 250 mL three necked round bottomed flask, equipped with a Friedrichs condenser (12° C.), was loaded with 42.68 g of a solution comprised of 1,3-diphenylpropane (69.54%), toluene (9.50%) and 20.96% structurally similar aromatic compounds. The reactor overhead was connected by ¼-inch PTFE to an alkaline water scrubber solution (110 mL H₂O, 15 mL 25% NaOH) contained within a 250 mL gas absorption bottle. Bromine was vaporized and conveyed at 30 mL/min through a ⅛ in. PTFE tubing as a subsurface feed (ca. ½ in.) into the reaction mass (46-51° C.). The evolved gas contained nitrogen and HBr which was essentially free of bromine. Analysis of the colorless primary scrubber (153.93 g including rinse water) showed 2.79% bromide and, after acidication, addition of 20% KI, and titration with 0.1N Na₂S₂O₃, we noted 76 ppm bromine (0.004 g total or 0.04% of the initial bromine) This indicates removal of 99.96% of the bromine from the eluent gas.

### Example 5

A preheated (80° C.) 250 mL three necked round bottomed flask, equipped with a Friedrichs condenser (25 C), was loaded with 93.523 g (0.277 mol) of a solution containing 36.9% three ring aromatics (including p-Bis(phenylethyl)benzene), 35.78% four-ring aromatics, including 4,4′-(diphenylethyl)bibenzyl, and the balance being structurally similar aromatic components. The reactor overhead was connected by ¼ in. PTFE to 110.94 g water scrubber solution contained within a 250 mL gas absorption bottle. A secondary scrubber contained 15 mL CCl₄ to trap any traces of residual bromine. Bromine (2.616 g, 0.016 mol) was vaporized and conveyed at 30 mL/min through a ⅛ in. PTFE tubing as a subsurface feed (ca. ½ in below liquid.) into the reaction mass (initially 105 C). The evolved gas contained nitrogen, HBr, and was essentially free of bromine After 1 hour 12 minutes, the addition step was completed and after a total time of 1 hour 23 minutes, the reaction mass and scrubber solutions were isolated and analyzed. Bromine removal was evidenced by the colorless appearance of the scrubber and its low bromine content (<28 ppm). The secondary scrubber (CCl₄) was also colorless after the feed and cook steps.

Example 6 illustrates the very high selectivity of aliphatic side-chain bromination achievable by the practice of this invention.

### Example 6

A jacketed 500 mL gas absorption bottle was placed between a gas inlet and a water scrubber comprised of a second gas absorption bottle containing water (170.07 g final wt). Both were stirred using a hot plate stirrer and a 1-inch stir bar. Bromine (49.9 g; 0.312 mmols) was conveyed over ca. 1.5 hours into the primary scrubber, which contained 283.25 g of oligomeric diarylethanes (0.838 mol at an avg MW of 338 g/mol) with no catalyst. The primary absorber had an oil jacket which had a maximum average temperature of 83.5° C. Upon completion of the experiment, it was noted that the water scrubber was entirely colorless, indicating that all bromine had been reacted in the primary absorber and no detectable bromine had carried forward into the water absorber. This was confirmed by the absence of any significant color observed upon addition of an analytical aliquot (ca. 2 g) into a solution of 20 mL of 20% potassium iodide. To determine the amount of recoverable HBr in the organic product, it was analyzed by ¹H-NMR as described in Comparative Example 1. Analysis of the aliphatic portion (δ2.7 ppm-0-5.5 ppm) of the complex mixture showed monobrominated products of bromination on the aliphatic chain (14.86%), dibrominated bridge bromination (7.51%% wt), with no products of aromatic bromination detected. Analysis of the olefinic region showed 1.89% wt dehydrobromination (stilbene-like) products.

The example below demonstrates the uncatalyzed preparation of a mixture featuring dibromination on the aliphatic bridge and, via its TGA data, its limited thermal stability. This feature is especially advantageous for recovery of the bromide using thermal dehydrobromination.

### Example 7

A jacketed 500 mL gas absorption bottle was placed between a gas inlet and a water scrubber comprised of a second gas absorption bottle containing water (206.89 g final wt). Both were stirred using a hot plate stirrer and a 1-inch stir bar. Bromine (136.55 g, 0.856 mols) was conveyed into the primary scrubber, which contained 144.78 g of oligomeric diarylethanes (0.428 mol at an avg MW of 338 g/mol). The primary absorber had an oil jacket which had a final average temperature ranging from 92° C. to 96° C. Upon completion of the experiment, it was noted that the water scrubber (nonoptimized) was pale yellow, and its final bromine concentration was 756 ppm. HBr recovered in the water absorber was 72.59 g or 104.68% of theory, indicating both bromination reaction completion and partial dehydrobromination of the aliphatic bridge. ¹H-NMR analysis of the aliphatic portion (δ2.7 ppm-0-5.5 ppm) of the complex mixture showed the products to be those of bridge dibromination. The product was a solid at 25° C. yet fluid at 90-105° C. It was additionally characterized in terms of its viscosity (>200 cP at 80° C., 84.5 cP at 90° C., and 17 cP at 105° C.), density (1.298 g/mL at 90° C., 1.283 at 105° C.) and by TGA: 1% wt loss at 105° C., 5% wt loss at 166° C., and 10% wt loss at 189° C., with 50% wt loss at 253.5° C.). This TGA data indicates the temperatures to achieve thermal dehydrobromination with elimination (and potential recovery) of anhydrous HBr.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure.

The invention may comprise, consist, or consist essentially of the materials and/or procedures recited herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to only the particular exemplifications presented hereinabove.

1. A process for selectively removing bromine from a vapor phase mixture of gaseous hydrogen bromide and gaseous bromine, which process comprises subjecting said mixture to free radical (benzylic) liquid phase bromination in a medium comprised of (1) one or more alkylene-bridged aromatic hydrocarbons, (2) one or more aryl-substituted linear alkanes having in the range of 2 to about 6 aryl groups per molecule, (3) one or more primary or secondary alkyl-substituted aromatic hydrocarbons in which the alkyl substituents each contain in the range of 2 to 6 carbon atoms, or (4) a mixture comprised of any two or all three of (1), (2), (3) and recovering gaseous HBr from said medium.

2. A process as in claim 1 wherein said medium is composed completely of one or more hydrocarbons of or including (1), (2), (3), or (4) except for hydrocarbon species formed by bromination therein.

3. A process as in claim 1 wherein said medium is comprised of (1) one or more alkylene-bridged aromatic hydrocarbons or (2) one or more aryl-substituted linear alkanes having in the range of 2 to about 6 aryl groups per molecule, or a mixture of (1) and (2).

4. A process as in claim 3 wherein said medium is comprised of one or more alkylene-bridged aromatic hydrocarbons.

5. A process as in claim 3 wherein said medium is comprised of one or more aryl-substituted linear alkanes having in the range of 2 to about 6 aryl groups per molecule.

6. A process for purifying an anhydrous vapor phase mixture comprised of gaseous hydrogen bromide contaminated with gaseous bromine, which process comprises
A) feeding said vapor phase mixture into a medium that has a liquid phase and that is devoid of any added bromination catalyst, and wherein the medium is formed from and contains:
(1) one or more alkylene-bridged aromatic hydrocarbon compounds of either or both of formulas (I) and (II):
Ar-alkylene-AE-alkylene-Ar (I)
Ar-alkylene-AE-alkylene-AE-alkylene-Ar (II)
wherein the Ar groups can be the same or different and each Ar is, independently, a C₆₋₁₆ unsubstituted or alkyl-substituted aryl group; wherein the AE groups can be the same or different and each AE is, independently, a C₆₋₁₆ unsubstituted or alkyl-substituted arylene group; and wherein the alkylene groups can be the same or different and each alkylene group is a C₂₋₁₀ alkylene group, and wherein all of the alkylene groups are, independently, linear alkylene groups, (—CH₂—)ₘ wherein m is 2-10; and/or
(2) one or more aryl-substituted linear alkanes of either or both of formulas (III) and (IV):
Ar—CH₂CH₂CH₂—Ar (III)
Ar—CH₂[—CH₂CH(Ar)]ₙ—CH₂CH₂—Ar (IV)
wherein each Ar is the same or different and is an aryl hydrocarbon group which can be unsubstituted or substituted by a straight chain alkyl group, each of which contains at least 2, and typically no more than about 4 or 5 carbon atoms, and n is a whole number in the range of 1 to about 4;
(3) one or more alkyl-substituted aromatic hydrocarbons of formula (V):
Rₚ—Ar (V)
wherein each R is a straight chain alkyl group, and wherein the alkyl groups independently contain in the range of 2 to 6 carbon atoms, Ar is a phenyl group, a naphthyl group, a biphenylyl group, or an anthryl group, and p is a whole number from 1 to 3; and/or
(4) a mixture of any two or all three of (1), (2), (3);
said medium being maintained at about 45 to about 110° C. and preferably at about 60 to about 110° C. so that free radical benzylic bromination occurs in said medium; and
B) recovering purified gaseous hydrogen bromide from said medium, and
C) optionally, subjecting residual medium from B) to thermal or catalytic dehydrobromination, thereby producing recoverable or directly useable additional hydrogen bromide.

7. A process as in claim 6 wherein said medium used in the process is formed from and contains one or more of said alkylene-bridged aromatic hydrocarbon compounds of either or both of formulas (I) and (II) wherein each said alkylene group is a C₂₋₆ alkylene group and wherein said m is 2-6.

8. A process as in claim 6 wherein said medium used in the process is formed from and contains one or more of said aryl-substituted linear alkanes of either or both of formulas (III) and (IV) wherein each said aryl hydrocarbon group is an unsubstituted aryl hydrocarbon group, preferably a phenyl group.

9. A process as in claim 6 wherein said medium used in the process is formed from and contains one or more alkyl-substituted aromatic hydrocarbons of formula (V) wherein each R is a straight chain alkyl group, and wherein the alkyl groups independently contain in the range of 2 to 6 carbon atoms.

10. A process as in claim 6 wherein in C) said residual medium from B) is subjected to thermal or catalytic dehydrobromination, thereby producing recoverable or directly useable additional hydrogen bromide.

11. A process as in claim 6 wherein said medium used in the process is a medium formed from and containing components of formula (I) and/or formula (II) wherein the Ar groups in formulas (I) and (II) are predominately (i.e. at least 50% of them are) phenyl groups, wherein the AE groups in formulas (I) and (II) are predominately (i.e. at least 50% of them are) phenylene groups, and wherein the alkylene groups in formulas (I) and (II) are predominately dimethylene groups.

12. A process as in claim 6 wherein said medium used in the process is a medium formed from and containing aromatic hydrocarbon components (i) comprising at least about 60 area %, as determined by GC-MS of components having empirical formulas of C₂₂H₂₂ which is indicated to be 1,4-bis(phenethyl)benzene and C₃₀H₃₀ which is indicated to be 4,4′-bis(phenethyl)bibenzyl, with the balance of the content of the medium being composed of hydrocarbon components of or within the group of empirical formulas C₁₄H₁₄, C₁₄H₁₈, C₁₅H₁₆, C₁₆H₁₈, C₁₄H₁₂, C₁₇H₂₀, C₁₆H₁₄, C₁₆H₁₆, C₁₈H₁₈, C₂₀H₁₈, C₂₁H₂₁, C₂₂H₁₈, C₂₄H₂₆, C₂₅H₂₉, C₃₂H₃₄, C₃₂H₃₄, C₃₂H₃₂, all as determined by GC-MS.

13. A process as in claim 6 wherein said medium used in the process is a medium formed from and containing components of formula (III) and/or formula (IV) wherein the Ar groups in formulas (III) and (IV) are predominately unsubstituted phenyl groups, and wherein the medium optionally additionally contains toluene in an amount of no more than about 15 wt % based on the total weight of said medium.

14. A process as in claim 13 wherein said medium used in the process is a medium formed from and containing aromatic hydrocarbon components comprising apart from solvent(s), a total of at least about 50 area % as determined by GC-MS of a mixture of 1,3-diphenylpropane, 1,3,5-triphenylpentane, and 1,3,5,7-tetraphenylheptane, and which medium optionally contains one or more hydrocarbon solvents.

15. A process as in claim 14 wherein said medium contains apart from hydrocarbon solvent(s), an aromatic hydrocarbon mixture comprising (a) in the range of about 45 to about 65 area % of 1,3-diphenylpropane (b) in the range of about 25 to about 45 area % of 1,3,5-triphenylpentane, and (c) in the range of about 1 to about 15 area % of 1,3,5,7-tetraphenylheptane, all as determined by GC-MS.

16. A process as in claim 13 wherein said medium consists essentially of an aromatic hydrocarbon mixture comprising a total of at least about 80 area % as determined by GC-MS of a mixture of 1,3-diphenylpropane and 1,3,5-triphenylpentane.

17. A process as in claim 6 further comprising limiting the amount of the feed of said gaseous mixture into said medium so that the total amount of bromination occurring in said medium does not exceed an average of more than about one bromine atom per molecule of said one or more compounds.

18. A process as in claim 6 wherein residual medium from B) is subjected to thermal or catalytic dehydrobromination thereby producing recoverable or directly usable additional hydrogen bromide.
